(19) United States
(12) Patent Application Publication
(10) Pub. No.: US 2008/0193157 A1
(43) Pub. Date: Aug. 14, 2008

(54) Media Determination

(75) Inventors: Jerry Shelton, Meridian, ID (US); Paul M. Dunn, Garden Valley, ID (US); Darlene S. Sams, Boise, ID (US); Charles Fuqua, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY, L.P., Fort Collins, CO (US)

(21) Appl. No.: 11/674,759

(22) Filed: Feb. 14, 2007

(51) Int. Cl. G03G 15/00

(52) U.S. Cl. 399/82

(57) ABSTRACT

Embodiments of media determination are disclosed.

### BACKGROUND

Different types of print media often use different types or levels of processing by printing devices.

Many printing devices are capable of operating in different print modes that are designed to accommodate different types of print media. Unfortunately, it is not always easy for the printing device user to determine which of those modes is most appropriate for print media on which the user wishes to print.

### BRIEF DESCRIPTION OF THE DRAWINGS

The disclosed printing devices can be understood with reference to the following drawings. The components in the drawings may not be to scale.

FIG. 1 is a perspective view of a first embodiment of a printing device that has print media type identification capability.

FIG. 2 is a schematic side view of an embodiment of architecture for the printing device shown in FIG. 1.

FIG. 3 is a schematic view that depicts an example of using the printing device of FIG. 1 to identify a print media type.

FIG. 4 is flow diagram of an embodiment of a method for determining a print media type and identifying that type to a user.

FIG. 5 is a schematic view of a second embodiment of a printing device having print media type identification capability.

FIG. 6 is a schematic view of a third embodiment of a printing device having print media type identification capability.

FIG. 7 is a schematic view of a fourth embodiment of a printing device having print media type identification capability.

### DETAILED DESCRIPTION

As described above, it can be difficult for users to determine which of multiple print modes to select for printing on given print media. Moreover, printing devices that automatically sense the media type and automatically select the print mode can, in some cases, frustrate the user. Disclosed in the following, however, are printing devices that can be used to determine the type of print media that the user possesses and further explicitly identify the print mode that will result in the best print quality for that media, while still leaving the user with the possibility of printing in an alternative print mode. In some embodiments, the user can have the printing device determine the print media type even if the user does not wish to print on the media using that printing device.

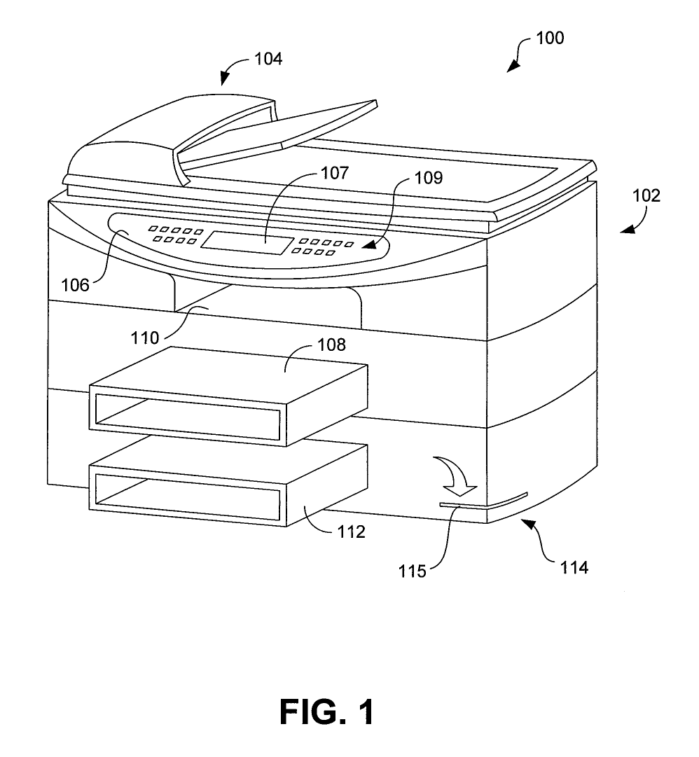

Referring to the figures, in which like numerals indicate corresponding parts throughout the several views, FIG. 1 illustrates an example printing device 100 having print media type identification capability. For the purposes of this disclosure the term “printing device” is an inclusive term used to identify devices that are capable of printing text, graphics, and/or images on print media. Therefore, “printing device” extends to printers and additionally to photocopiers, facsimile machines, multifunction peripheral devices (“all-in-one” devices), and other office-type peripheral devices that are configured to output printed documents. Notably, a multifunction peripheral device that is capable of printing, photocopying, and scanning is illustrated in the figures by way of example.

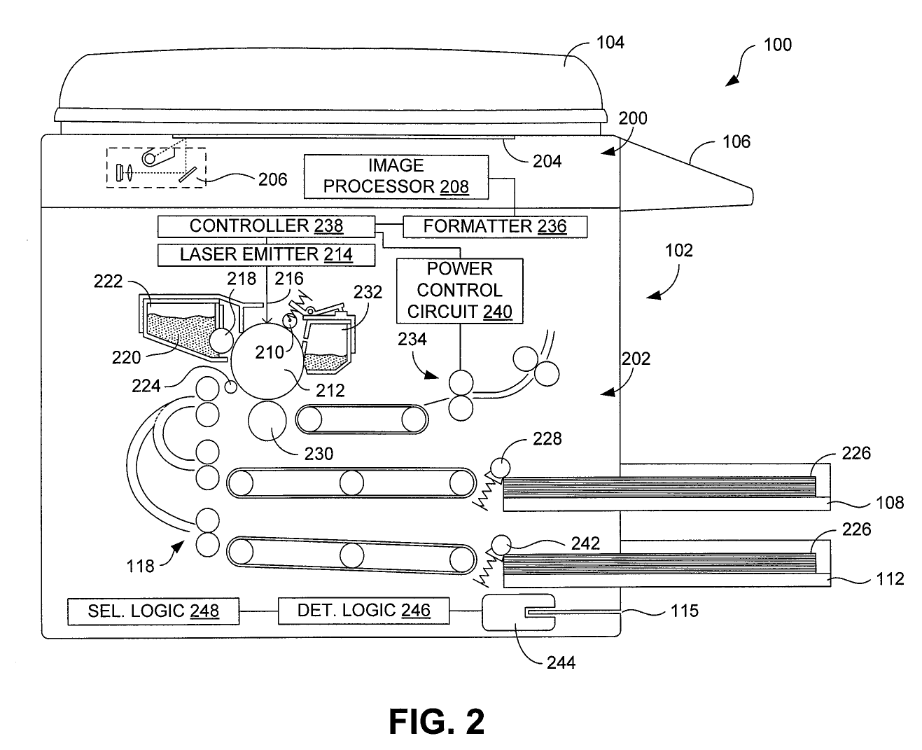

As indicated in FIG. 1, the printing device 100 comprises an outer housing 102 that encloses an internal print mechanism (see FIG. 2). Provided on the outer housing 102 in the embodiment of FIG. 1 is an automatic document feeder (ADF) 104 that draws print media into the printing device 100 for the purpose of scanning and/or photocopying. Therefore, in the embodiment shown in FIG. 1, the outer housing 102 further encloses a scanning mechanism (see FIG. 2).

Further provided on the housing 102 is a control panel 106 that can be used to control operation of the printing device 100 and adjust device settings. By way of example, the control panel 106 comprises a display 107 and plurality of buttons 109 that are used to select user selectable features shown in the display. Supported by the housing 102 is a first media input tray 108 that is configured to hold media, such as paper and transparencies, for input into the printing device 100 to facilitate printing and/or photocopying. The housing 102 includes one or more output areas 110 at which printed media are output from the printing device 100. The housing 102 further supports at least one further media input tray 112 that, like input tray 108, is configured to hold media for input into the printing device 100. In the embodiment of FIG. 1, the input tray 112 can be designated the second media input tray.

Further provided on the housing 102 is an integral print media evaluation feature 114 that is adapted to receive print media that is to be evaluated to determine the print media type for the purpose of identifying the media type to the user and/or selecting a print mode for the media. In the embodiment of FIG. 1, the feature 114 comprises an opening in the form of a relatively narrow slot 115 that is sized and configured to receive a single sheet of print media, whether it be relatively thin or relatively thick print media. By way of example, the slot 115 is adapted to receive a corner portion of the print media. With such an arrangement, print media type detection hardware contained within the printing device 100 (described below) is at least partially shrouded from ambient light that could potentially affect the print media type determination. In FIG. 1, the position of the print media evaluation feature 114 is shown adjacent the bottom of the printing device 100. That positioning is shown for purposes of example, however, and it is to be appreciated that the feature 114 can be provided in other locations, such as adjacent the control panel 106. Indeed, the feature 114 can be provided in any location that is deemed suitable from a user interfacing perspective, manufacturing perspective, or other consideration. In addition, although a slot 115 is illustrated in FIG. 1, the feature 114 may, in other embodiments, not be configured as a slot. Indeed, an opening may not be included in other embodiments. Instead, a print media evaluation feature can be mounted to the exterior of the printing device housing 102 in substantially any manner in which the print media can be evaluated to determine its type.

Irrespective of its positioning, the print media evaluation feature 114 is an external feature accessible from the exterior of the printing device housing 102. Therefore, the user may not input the print media into the printing device 100 or run the media through any of the printing device's print paths to identify the print media type.

FIG. 2 is a schematic view of an example architecture of internal mechanisms of the printing device 100 of FIG. 1. As indicated in FIG. 2, the printing device 100 comprises a scanning unit 200, which is responsible for scanning media, and a printing unit 202, which is responsible for generating hard copy documents. The scanning unit 200 comprises a platen 204 on which media to be scanned may be positioned, a scanning module 206 that is used to capture image data from the media, and an image processor 208 that processes the captured image data, for instance for the purpose of printing by the printing unit 202. The scanning module 206 may comprise, for example, a light source, a reflector, and an image sensor, such as a linear photosensor array (e.g., linear charge-coupled device (CCD)). The scanning module 206 can be configured to travel along the length of the platen 204 (or a portion thereof where appropriate) to scan media placed on the platen.

The printing unit 202 comprises the print mechanism that is used to generate hard copy documents, either from data provided by a host device (e.g., personal computer (PC)) or by the scanning unit 200. In the example of FIG. 2, the print mechanism is a laser print mechanism. It is noted, however, that the print mechanism could, alternatively, comprise an ink print mechanism or other suitable print mechanism. The print mechanism shown in FIG. 2 includes a charging apparatus 210, such as a charge roller, that is used to charge the surface of a photoconductor member 212, such as a photoconductor drum, to a predetermined voltage. By way of example, the photoconductor member 212 comprises an organic photoconductor (OPC).

A laser diode is provided within a laser emitter 214 that emits a laser beam 216 that is pulsed on and off as it is swept across the surface of the photoconductor member 212 to selectively discharge the surface of the photoconductor member. In the orientation shown in FIG. 2, the photoconductor member 212 rotates in the counterclockwise direction. A developing member 218, such as a developing roller, is used to develop a latent electrostatic image residing on the surface of photoconductor member 212 after the surface voltage of the photoconductor member has been selectively discharged. The developing member 218 develops the image using toner 220 that is, for example, stored in a toner reservoir 222 of a removable print cartridge. The developing member 218 can, for instance, include an internal magnet (not shown) that magnetically attracts the toner 220 from the toner reservoir 222 to the surface of the developing member. As the developing member 218 rotates (clockwise in FIG. 2), the toner 220 is attracted to the surface of the developing member and is then transferred across a gap between the surface of the photoconductor member 212 and the surface of the developing member to develop the latent electrostatic image. In an alternative embodiment, the print mechanism can include an erasing apparatus, such as an erase lamp 224, that is used to erase at least a portion of the latent electrostatic charge on the surface of the photoconductor member 212 after transfer of the toner to a recording medium.

Print media 226, for instance sheets of paper, are loaded from the input tray 112 by a pickup roller 228 into a conveyance path of the printing device 100. Each sheet of print media 226 is individually drawn through the device 100 along the conveyance path by various drive rollers and/or conveyors (unnumbered) such that the leading edge of each sheet is synchronized with the rotation of the region on the surface of the photoconductor member 212 that comprises the developed toner image. As the photoconductor member 212 rotates, the toner adhered to the member contacts the sheet, which has been charged by a transfer member 230, for example a transfer roller, such that the toner particles are moved away from the surface of the photoconductor member and onto the surface of the sheet.

The transfer of toner particles from the surface of the photoconductor member 212 to the surface of the sheet normally is not completely efficient. Therefore, if toner particles remain on the surface of the photoconductor member 212, those toner particles are removed from the photoconductor member and deposited in a toner waste hopper 232. As the sheet of print media moves along the conveyance path past the photoconductor member 212, the recording medium is delivered to a fusing system 234 that, for example, comprises a fuser roller and a pressure roller that form a nip that applies heat and pressure to the sheet to fuse the toner to the surface of the sheet. After fusing is completed, the sheet is output from the printing device 100, for instance in the output area 110 (FIG. 1).

As identified in FIG. 2, the printing unit 202 further includes a formatter 236 and an printing device controller 238. The formatter 236 receives data transmitted from a host device or received from the image processor 208 and converts the data into a stream of print data that is sent to the controller 238. The formatter 236 and the controller 238 exchange data used for controlling the printing process, and the controller supplies the stream of print data to the laser emitter 214. The print data stream sent to the laser emitter 214 causes the laser diode of the emitter to pulse on and off to create the latent electrostatic image on the photoconductor member 212.

In addition to providing the print data stream to the laser emitter 214, the controller 238 controls a high voltage power supply (not shown) that supplies voltages and currents to the components used in the printing device 100. The controller 238 further controls a drive motor (not shown) that drives the printer gear train (not shown) as well as the various clutches and feed rollers (not shown) used to move print media 226 through the conveyance path of the device 100. A power control circuit 240 controls the application of power to the fusing system 234.

The second media input tray 112 also holds print media 226 which are fed up to the main unit 102 with a pickup roller 242 and various drive rollers and/or conveyors through the opening 118.

As is further indicated in FIG. 2, the printing device 100 comprises a print media type detection device 244 that is coupled with print media type determination logic 246. The print media type detection device 244 comprises one or more sensors that are used to detect the type of print media that has been inserted into the print media evaluation slot 115. In terms of “type,” at issue is the nature of the print media in terms of composition, thickness, weight, surface characteristics, and the like as opposed to other attributes such as size or aspect ratio. In some embodiments, the detection device 244 comprises a light source, such as a laser, and one or more light detectors that detect light emitted from the light source. In such a case, the type of print media can be determined by whether the light passes through the print media and/or the nature of the light that is reflected by the media. Examples of such detection devices are provided in U.S. Pat. No. 6,497,179, U.S. Pub. No. 2003/0137679, and U.S. Pub. No. 2005/0219305, which are hereby incorporated by reference into the present disclosure. In other embodiments, the detection device 244 comprises a heating element and a heat sensor. In such embodiments, the print media type can be determined by heating the media and detecting the heat capacity of the media. An example of such a detection device is provided in U.S. Pat. No. 6,726,357, which is hereby incorporated by reference into the present disclosure. Irrespective of the particular nature of the print media type detection device 244, the detection device least in some embodiments, further includes a sensor for automatically detecting the presence of print media placed within the print media evaluation slot 115 such that the detection device automatically operates to detect the media type when a sheet of media is placed within the slot.

Information collected by the detection device 244 is provided to the print media type determination logic 246, which makes the determination as to the media type and identifies the type to the user. By way of example, the detection logic 246 comprises firmware stored in memory of the printing device 100 that is executed by the controller 238 or other processor or control unit. Associated with the detection logic 246 is print mode selection logic 248 that, as described below, selects a print mode that will result in the highest print quality in relation to the detected print media and either automatically activates that mode or identifies the mode to the user, for example using the control panel 106.

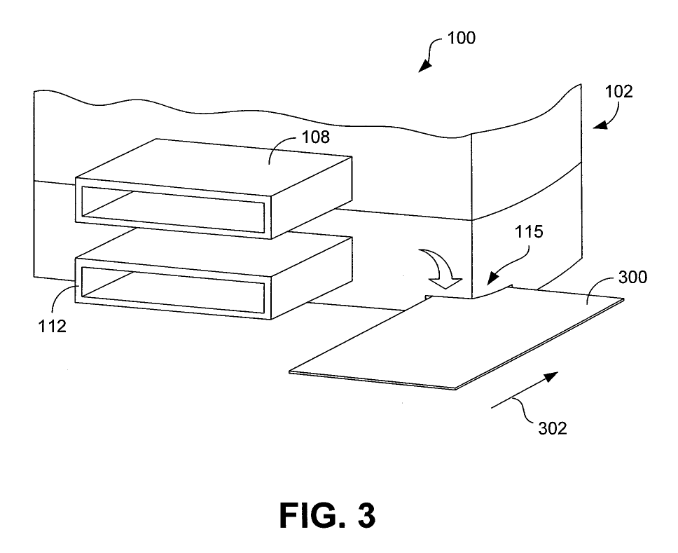

FIG. 3 illustrates an example use of the printing device 100 to identify print media type. In the example of FIG. 3, a sheet 300 of print media is inserted into the slot 115 in the direction of arrow 302. Once the sheet 300 is inserted into the slot 115, the detection device 244 (FIG. 2) collects information from the sheet and provides it to the determination logic 246 for evaluation. After the type of media has been determined by the determination logic 246, various actions can be performed by the printing device 100 as well as the user, as described in the following.

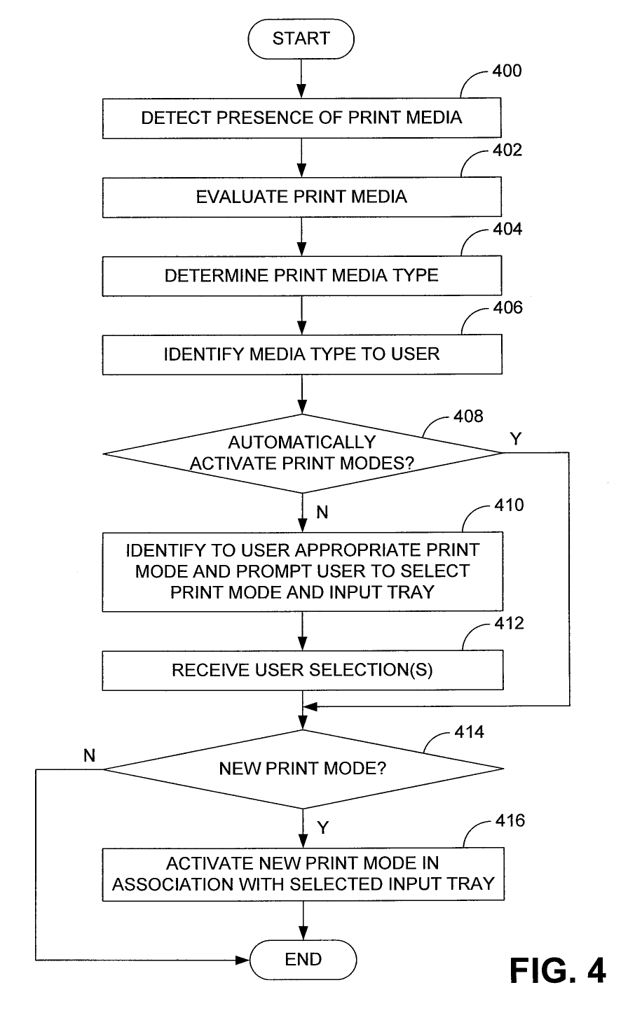

FIG. 4 is a flow diagram of an example method for detecting a print media type and controlling a printing device to identify the media type to the user and either suggest a print mode or automatically activate a print mode depending upon printing device configuration. Beginning with block 400, the presence of a sheet of print media is detected by the print media type detection device when the user places the sheet within the print media evaluation feature of the printing device. Once the sheet has been detected, the detection device operates to evaluate the print media, as indicated in block 402. The nature of operation of the detection device of course depends upon its nature. In cases in which the detection device comprises a light source and detector, the detection device shines light (e.g., laser light) on the print media and collects information as to the transmission and/or reflection of the light so that information can be shared with the print media type determination logic. Next, with the assistance of the print media type determination logic, the type of the print media is determined, as indicated in block 404.

After the print media type determination has been made, the print media type can be explicitly identified to the user, as indicated in block 406. By way of example, the print media type can be identified to the user with a print media type name and/or description with the control panel display of the printing device. Alternative identification methods are possible, however. For example, the print media type can be transmitted from the printing device to the user's host printer, audibly identified using a speaker of the printing device, or printed on a sheet of media already resident in an input tray of the printing device.

At this point, flow for the example method of FIG. 4 depends upon the configuration of the printing device. In particular, with reference to decision block 408, flow depends upon whether the printing device is configured to automatically select and activate an appropriate print mode for the determined print media or whether the selection and activation is to be left to the user. In the former case, flow continues to decision block 414 described below. In the latter case, however, flow continues to block 410 at which the print mode selection logic identifies to the user the appropriate print mode for the identified print media, in terms of optimal print quality, and prompts the user to select the print mode and tray from which the identified print media will be drawn during printing. By way of example, the prompting can occur in the form of a recommendation of a print mode and media tray and querying the user to accept or deny the recommendation. In alternate embodiments, other information, such as the print speed associated with the recommended print mode, can be identified to the user. Again, the information can be provided to the user with the control panel display or other appropriate communication medium.

Once the print mode has been identified, the user has several possibilities from which to select. For example, if the printing device provided a recommendation of a print mode and media tray, the user can select that mode and tray, for instance through selection of an appropriate button of the control panel. Alternatively, the user can disregard the recommendations and maintain present default settings of the printing device by declining the recommended new print mode. As a further alternative, the user can do nothing, for example a case in which the user merely wanted to identify the print media type and does not wish to print on the media using the printing device. In such a case, the printing devices detection device and logic are used as stand alone service and print media type can be determined completely independent of the printing process, if desired. Accordingly, it can be appreciated that a large degree of control over printing, or not printing, is provided to the user even though the printing device is configured to detect media types and select appropriate print modes.

Assuming the user does wish to print on the printing device using the identified print media, the user then registers his or her selections as to print mode and/or media input tray and the selection(s) is/are received by the printing device, as indicated in block 412. Referring to decision block 414, if the user's selections indicate a change in print mode, the print mode selection logic activates a new print mode in association with the selected media input tray (e.g., the second media tray), as indicated in block 416. As described above, activation of a new print mode may result in a change of the rate at which the print media traverses the print path within the printing device or the temperature at which toner is fused to the print media. In cases in which the printing device is an inkjet printer, activation of a new print mode may result in a change of the color table, ink densities, or other print quality enhancements. If, on the other hand, no new print mode is indicated, no changes are made and flow for the media type identification session is terminated.

At this point, the user can load the selected media input tray with the identified print media, if desired, and initiate whatever printing device function (e.g., printing, photocopying, scanning) the user wishes to use.

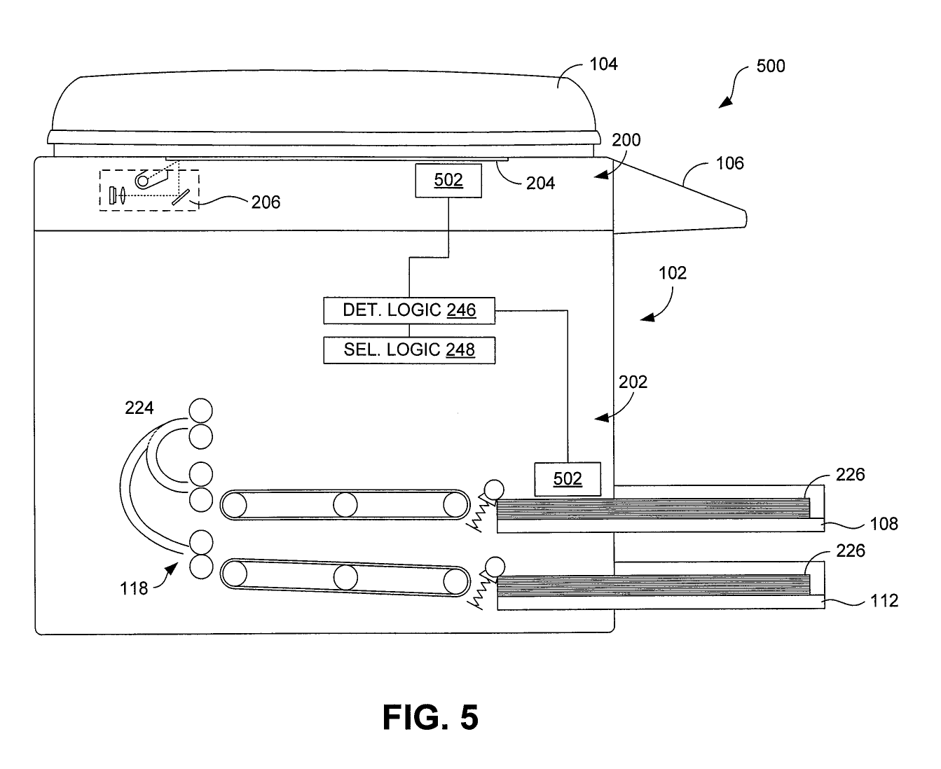

FIG. 5 illustrates a further embodiment of a printing device 500 (components of the printing device omitted for purposes of clarity). Generally speaking, the printing device 500 is similar to the printing device 100 of FIG. 1 except that a print media type detection device 502 is provided adjacent the platen 204 and/or the first media input tray 108. In such an arrangement, print media type can be determined and identified to the user by placing the print media within a media input location of the printing device 500.

Use of the printing device 500 is similar to that of the printing device 100. To determine print media type, the print media is positioned in a place in which one of the detection devices 502 can evaluate the print media. For example, if the printing device is provided with a detection device 502 adjacent the platen 204, the print media can be placed on the platen for evaluation. If, on the other hand, the printing device is provided with a detection device 502 adjacent the media input tray 108, the print media can be placed in the media input tray. Once the print media is placed in the appropriate location, the user can initiate print media type evaluation by entering an appropriate command into the control panel 106. If the printing device 500 is equipped with multiple detection devices 502, the user entry may further specify the placement of the print media. Thereafter, the printing device 500 can determine the print media type and identify it to the user in similar manner to that described above. As with operation of the printing device 100, the printing device 500 may not be used to actually print after the print media type has been identified. Accordingly, the printing device's print media identification functionality can be used independent of the printing process as with the printing device 100.

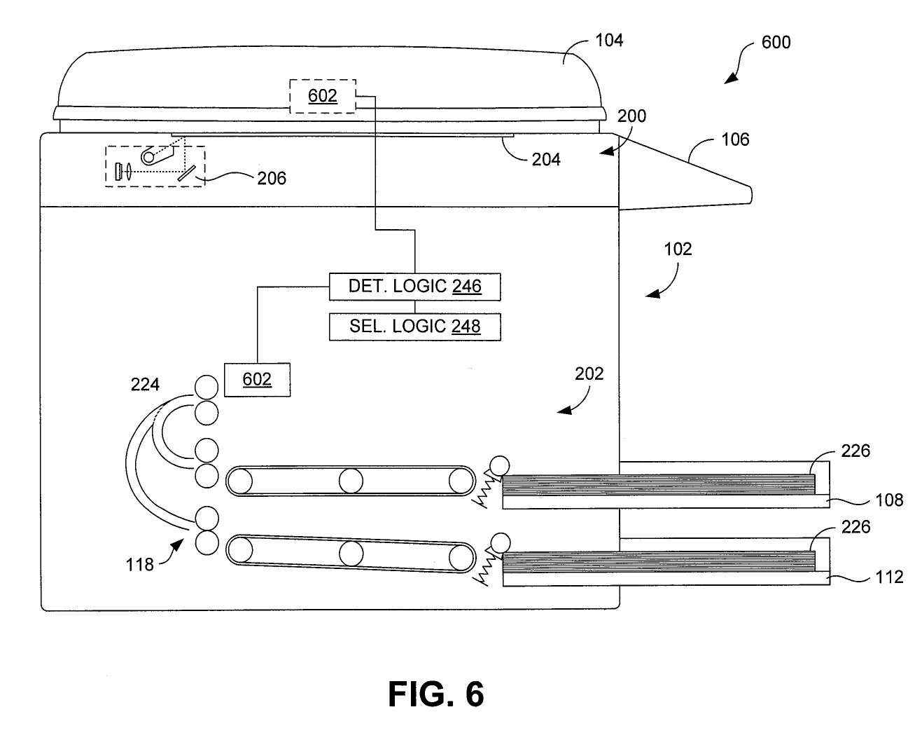

FIG. 6 illustrates yet another embodiment of a printing device 600 (components of the printing device omitted for purposes of clarity). The printing device 600 is also similar to the printing device 100 of FIG. 1 except that print media type detection devices 602 are positioned along print paths of the printing device. In such an arrangement, print media type can be determined and identified to the user by running the unknown print media through a media path of the printing device 600, for example after requesting print media identification through entry of an appropriate command into the control panel 106. By way of example, the print media can be run through the ADF 104 or can be input into the device print path using a media input tray (e.g., the first media input tray 108). Again, the detection devices 602 can be used to identify the print media type to assist the user with selection of an appropriate print mode for printing on the printing device 600, or can simply be used to identify the print media type for the user's knowledge.

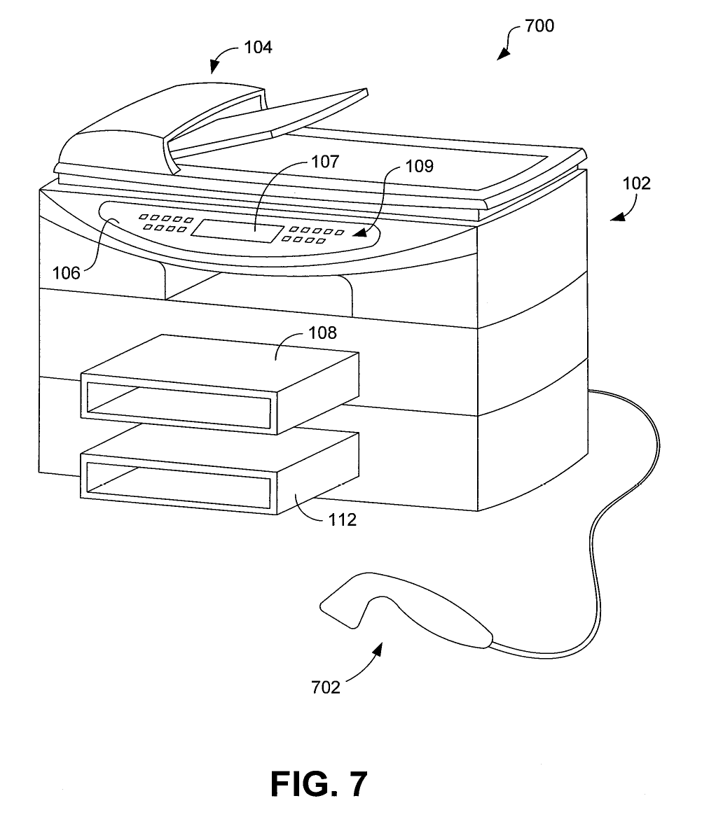

FIG. 7 illustrates yet a further embodiment of a printing device 700, which is also similar to the printing device 100 of FIG. 1 except that a handheld scanner 702 is provided that contains the print media type detection device instead of the printing device itself. Therefore, print media type can be determined by scanning over the print media with the scanner 702 instead of inserting the print media within the printing device 700 in some manner.

While particular embodiments have been disclosed in detail in the foregoing description and drawings for purposes of example, it will be understood by those skilled in the art that variations and modifications thereof can be made without departing from the scope of the disclosure.

What is claimed is:

1. A method for identifying a print media type, the method comprising:
determining with a printing device a print media type presented by a user; and
explicitly identifying the print media type to the user using the printing device.

2. The method of claim 1, wherein determining a print media type comprises determining the print media type using a print media type detection device contained within an outer housing of the printing device.

3. The method of claim 2, wherein the print media type detection device is accessible through an opening provided in the printing device outer housing separate from a media input location of the printing device such that the detection device can be used independent of printing.

4. The method of claim 1, wherein identifying the print media type to the user comprises identifying the print media type with a display of the printing device.

5. The method of claim 1, further comprising determining a print mode that is most appropriate for the identified print media in terms of print quality.

6. The method of claim 5, further comprising identifying the determined print mode to the user and prompting the user to select a print mode on the printing device.

7. The method of claim 6, further comprising receiving the user print mode selection and activating the selected print mode.

8. The method of claim 6, further comprising automatically activating the determined print mode.

9. A printing device comprising:
a print media type detection device configured to evaluate sheets of print media; and
print media type determination logic configured to determine a print media type of an evaluated sheet of print media and to explicitly identify the print media type to a user.

10. The printing device of claim 9, further comprising an outer housing and wherein the print media type detection device is contained within the outer housing.

11. The printing device of claim 10, further comprising an opening provided in the outer housing that provides access to the print media type detection device such that the detection device can be accessed and used from the outside the outer housing and used independent of printing.

12. The printing device of claim 11, wherein the opening is a slot provided in the printing device outer housing that is configured to receive a sheet of print media.

13. The printing device of claim 10, further comprising a scanning unit including a platen and wherein the print media type detection device is located adjacent the platen such that print media type can be determined when a sheet of print media is placed on the platen.

14. The printing device of claim 10, further comprising a media input tray and wherein the print media type detection device is located adjacent the media input tray of the printing device such that print media type can be determined when a sheet of print media is placed in the input tray.

15. The printing device of claim 10, further comprising an automatic document feeder and wherein the print media type detection device is located within an automatic document feeder of the printing device and detects print media type when print media is fed through the automatic document feeder.

16. The printing device of claim 10, wherein the print media type detection device is located within a print path of the printing device that print media traverses during printing and wherein the detection device detects print media type when print media travels along the print path.

17. The printing device of claim 9, further comprising a handheld scanner that is coupled to the printing device and wherein the print media type detection device is contained within the scanner.

18. The printing device of claim 9, further comprising a display in which a determined print media type can be explicitly identified to the user.

19. The printing device of claim 9, further comprising print mode selection logic configured to select a print mode for a determined print media type.

20. A print system comprising:
means provided on a printing device for determining a print media type presented by a user; and
means for explicitly identifying the print media type to the user using the printing device.
